(19) United States
(12) Patent Application Publication
(10) Pub. No.: US 2007/0030292 A1
(43) Pub. Date: Feb. 8, 2007

(54) Apparatus and method for image rotation

(75) Inventors: Iming Pai, San Jose, CA (US); Huei-Mei Su, Cuperlino, CA (US); Yun Lin, San Jose, CA (US); Talen Tang, Shanghai (CN)

Correspondence Address: RABIN & Berdo, PC, 1101 14TH STREET, NW, SUITE 500, WASHINGTON, DC, 20005, US

(73) Assignee: VIA TECHNOLOGIES, INC.

(21) Appl. No.: 11/473,319

(22) Filed: Jun. 23, 2006

Related U.S. Application Data
(63) Continuation-in-part of application No. 10/654,905, filed on Sep. 5, 2003, now abandoned.

(30) Foreign Application Priority Data
Sep. 19, 2002 (TW) 91121428

(51) Int. Cl. G09G 5/00

(52) U.S. Cl. 345/649

(57) ABSTRACT

An apparatus for image rotation. The apparatus includes a first memory, a frame buffer, a rendering module, a rotation object determination module, a rotation module, and a replacing module. The rendering module renders a second image according to second image data. The rotation object determination module detects a variation between the first image and the second image to identify a first image variation object of the first image, a second image variation object of the second image, and a rotated first image variation object of the first rotation image. The rotation module rotates the second image variation object as a second image rotation object. The replacing module retains the first rotation image except the rotated first image variation object and replaces the rotated first image object of the first rotation image with the second image rotation object to form a rotated second image.

### CROSS REFERENCE TO RELATED APPILCATIONS

This application is a Continuation-In-Part of pending U.S. patent application Ser. No. 10/654,905, filed Sep. 5, 2003 and entitled “Apparatus and method for image rotation”.

### BACKGROUND OF THE INVENTION

1. Field of the Invention

The present invention relates to an apparatus and method for image rotation, and particularly to an apparatus and method that rotates only desired elements of the image without rendering the entire image.

2. Description of the Related Art

In computer graphics, various applications corresponding to display appliances are developed. For example, a system and function for image rotation has been developed to display data at different positions and angles, specifically for notebook users.

FIGS. 1a and 1b show schematic diagrams of image rotation corresponding to monitor and frame buffer respectively. In FIG. 1a, the image 100 in the monitor is rotated −90° as the image 101. The image data corresponding to the image in the monitor stored in the frame buffer of computer system is shown in FIG. 1b. The image data 111 stored in the frame buffer 110 corresponds to the image 100 in the monitor, and the image data 112 stored in the frame buffer 110 corresponds to the image 101 in the monitor.

In the conventional image rotation method, after new image data is received, both hardware rendering and software rendering methods first render a new image according to the new image data, and render a rotated image based on the entire image. Since the entire image contains a large amount of data, the rotation process takes up system resources and is time-consuming if the entire image is rendered to rotate. However, the difference between each image rendered by the system is minor in practice, when, for example, only one object is moved or a new object appears. Therefore, the conventional image rotation method is inefficient.

### SUMMARY OF THE INVENTION

The present invention provides an apparatus and method that rotates only desired elements of the image without rendering the entire image.

According to an embodiment of the invention, the apparatus includes a first memory, a frame buffer, a rendering module, a rotation object determination module, a rotation module, and a replacing module. The frame buffer stores a first rotation image corresponding to a first image. The rendering module renders a second image according to received second image data, and stores the second image in the first memory. The rotation object determination module detects a variation between the first image and the second image to identify a first image variation object of the first image, a second image variation object of the second image, and a rotated first image variation object of the first rotation image, wherein the first image variation object in the first image and the rotated first image variation object in the first rotation image are located at a position corresponding to that of the second image variation object in the second image. The rotation module rotates the second image variation object as a second image rotation object. The replacing module retains the first rotation image except the rotated first image variation object and replaces the rotated first image object of the first rotation image with the second image rotation object to form a rotated second image.

The apparatus further includes a display device to refresh and display the rotated second image in the frame buffer.

The first memory can be the system memory, and the rendering module and the rotation module can be implemented by software, and performed by CPU. Further, the first memory can be contained in the frame buffer, and the rendering module and the rotation module can be implemented by hardware, and performed by a graphics accelerator.

According to another embodiment of the invention, a method for image rotation is provided. First, second image data is received, and a second image is then rendered according to the second image data. Then, a variation between the first image and the second image is detected to identify a first image variation object of the first image, a second image variation object of the second image, and a rotated first image variation object of the first rotation image. The second image variation object is then rotated as a second image rotation object. Thereafter, the first rotation image except the rotated first image variation object is retained and the rotated first image object of the first rotation image is replaced with the second image rotation object to form a rotated second image.

The first rotation image is further stored in a frame buffer, and the rotated second image in the frame buffer is displayed.

The second image is further stored in the system memory, and the rendering and rotation processes can be performed by CPU. Further, the second image is further stored in the frame buffer, and the rendering and rotation processes can be performed by a graphics accelerator.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1a and 1b show the schematic diagrams of image rotation corresponding to monitor and frame buffer respectively;

FIG. 2a is a schematic diagram illustrating the system architecture of the apparatus for image rotation according to a first embodiment of the present invention;

FIG. 2b shows the first image, the first rotation image, the second image, and the rotated second image of the invention;

FIG. 3 is a schematic diagram illustrating the system architecture of the apparatus for image rotation according to a second embodiment of the present invention;

FIG. 4a is a schematic diagram illustrating a 2D texture rotated by 180° into 3D texture;

FIG. 4b is a schematic diagram illustrating a 2D texture rotated by 90° into 3D texture;

FIG. 5 is a flowchart illustrating the operation of the method for image rotation according to the embodiment of the present invention;

FIG. 6 is a schematic diagram illustrating an example of image rotation according to the embodiment of the present invention;

FIG. 7 is a schematic diagram illustrating an example of texture mapping;

FIG. 8 is a schematic diagram illustrating another example of image rotation according to the embodiment of the present invention; and

FIG. 9 is a schematic diagram illustrating the process of image rotation and image refreshing.

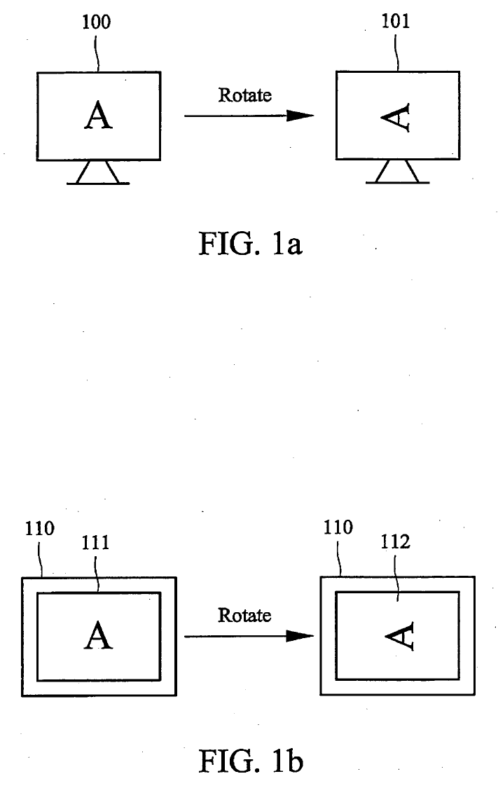

### DETAILED DESCRIPTION OF THE INVENTION

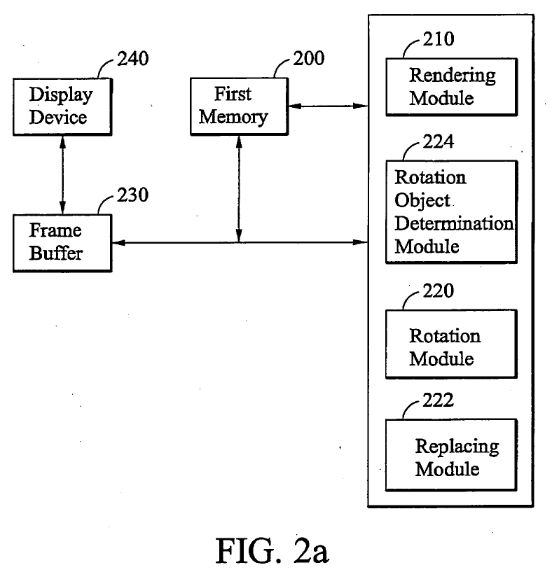

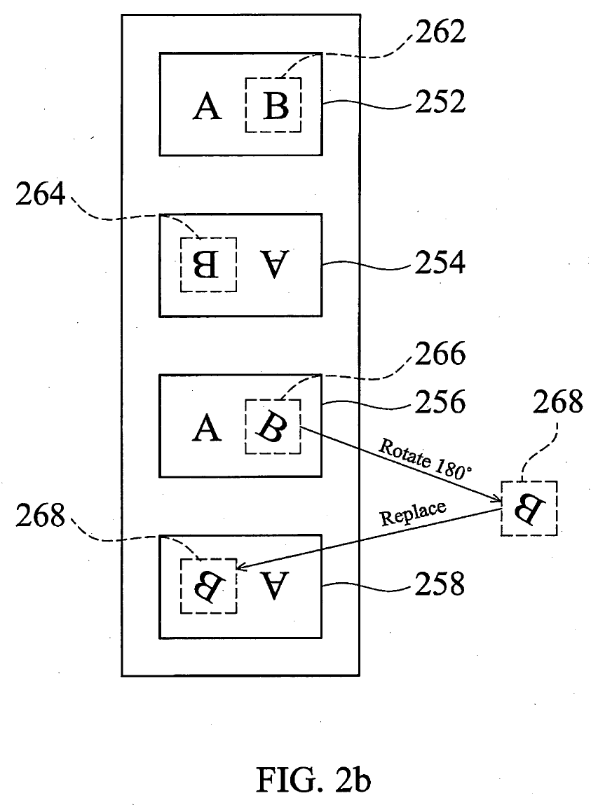

FIG. 2a illustrates the system architecture of the apparatus for image rotation according to the first embodiment of the present invention. The apparatus includes a first memory 200, a frame buffer 230, a rendering module 210, a rotation module 220, a replacing module 222, a rotation object determination module 224, and a display device 240. The rendering module 210, the rotation module 220, the replacing module 222, and the rotation object determination module 224 can be the components of a GPU (graphics processor unit).

The frame buffer 230 can be the memory on the DIMM (dual in-line memory module) or graphics adapter. The display device 240 refreshes and displays the image stored in the frame buffer 230.

Now refer to FIG. 2b, which shows a first image 252, a first rotation image 254, a second image 256, and a rotated second image 258 of the invention. The first image 252 is a prior image and includes a letter A and a letter B 262. The first rotation image 254 is a 180° rotated image of the first image 252. The second image 256 is the next rendering image of the first image 252 and includes a letter A and a slanted letter B 266. The rotated second image 258 is a 180° rotated image of the second image 256.

To obtain the rotated second image 258 served as the next image shown on the display device 240, the second image 256 may be directly rotated according to the conventional method. This, however, wastes system resources to rotate the whole image. If the first image 252, the first rotation image 254, and the second image 256 are all in existence, replacing the partial image 264 of the first rotation image 254 with a rotated image of the slanted letter B 266 of the second image 256 is a more rapid method to obtain the rotated second image 258. Thus, only the slanted letter B 266 changed between the first image 252 and the second image 256 needs to be rotated, and less system resource is required.

Now refer back to FIG. 2a. The frame buffer 230 stores the first rotation image 254. The rendering module 210 receives second image data from an application, and renders the second image 256 according to the second image data. After the second image 256 is rendered, it is stored in the first memory 200. The rotation object determination module 224 then detects a variation between the prior first image 252 and the second image 256, and identifies three variation objects: a first image variation object 262 of the first image 252, a second image variation object 266 of the second image 256, and a rotated first image variation object 264 of the first rotation image 254.

The variation between the first image 252 and the second image 254 are identified as the first image variation object 262 , which is the letter B portion of the first image 252, and the second image variation object 266, which is the slanted letter B portion of the second image 256. According to the variation between the first and second images 252 and 256, a rotated first image variation object 264, which is the rotated letter B portion of the first rotation image 254, can also be identified. The rotated first image variation object 264 is the partial image located at a position corresponding to that of the second image variation object 266.

Thus, to obtain the rotated second image 258, the 3D engine does not need to rotate the whole second image 256. The rotation module 220 then rotates the second image variation object 266 according to a rotation requirement as a second image rotation object 268 which includes a rotated slanted letter B. The replacing module 222 then retains the first rotation image 254 except the rotated first image variation object 264, and replaces the rotated first image object 264 of the first rotation image 254 with the second image rotation object 268 to form a rotated second image 258. It should be noted that the prior first image can be stored in the rotation module 220. Afterward, the display device 240 can refresh and display the rotated second image 258 in the frame buffer 230. It should be noted that the rotation requirement can be preset by the system or users.

In the first embodiment, the rendering module 210 and the rotation module 220 can be implemented by software (software rendering) and performed by the CPU (central processing unit). Further, the first memory 200 can be the system memory of a computer system when software rendering is utilized.

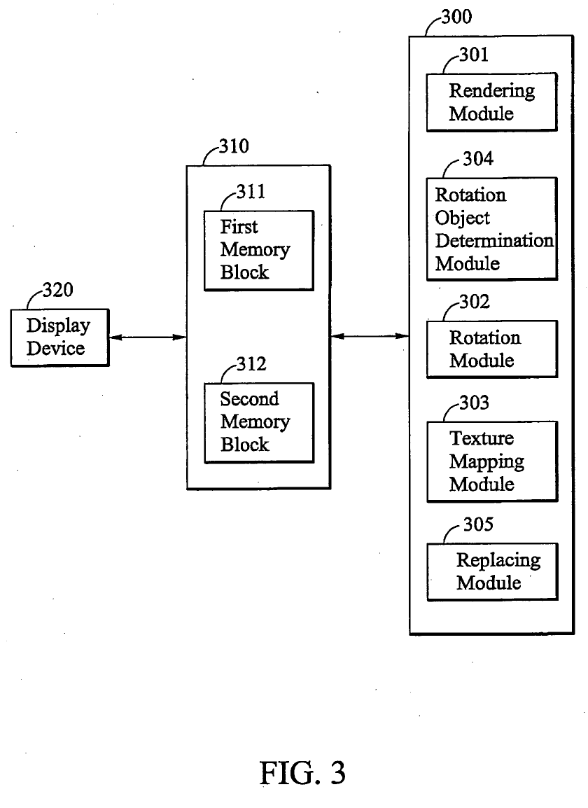

FIG. 3 illustrates the system architecture of the apparatus for image rotation according to a second embodiment of the present invention. The apparatus includes a 3D engine 300, a frame buffer 310, and a display device 320.

The frame buffer 310 includes a first memory block 311 and a second memory block 312. The display device 320 refreshes and displays the image stored in the second memory block 312.

The 3D engine 300 includes a rendering module 301, a rotation module 302, a texture mapping module 303, a rotation object determination module 304, and a replacing module 305. The rendering module 301 receives second image data from an application, and renders a second image 256 according to the second image data. For example, the rendering module 301 receives vertex data from the application and renders triangles of the second image according thereto. After the second image 256 is rendered, the rendering module 301 stores the second image 256 in the first memory block 311. The rotation object determination module 304 then detects a variation between the first image 252 and the second image 256 to identify a first image variation object 262 of the first image 252, a second image variation object 266 of the second image 256, and a rotated first image variation object 264 of the first rotation image 254. It should be noted that the prior first image 252 can be stored in the rotation module 302, and the first rotation image 254 is the image stored in the second memory block 312.

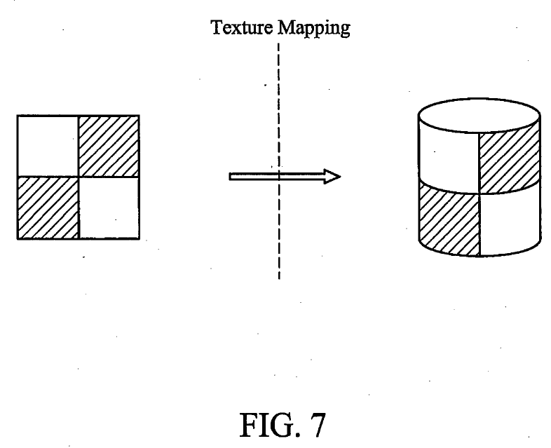

The rotation module 302 then rotates the second image variation object 266 according to a rotation requirement as a second image rotation object 268, and the texture mapping module 303 rotates a 2D texture as a 3D texture according to the rotation requirement and texture maps the 3D texture on the second image rotation object 268. It should be noted that an example of texture mapping is shown in FIG. 7. The replacing module 305 then retains the first rotation image 254 except the rotated first image variation object 264, and replaces the rotated first image object 264 of the first rotation image 254 with the second image rotation object 268 to form a rotated second image 258. Afterward, the display device 320 can refresh and display the rotated second image 258. It should be noted that the rotation requirement can be preset by the system or users.

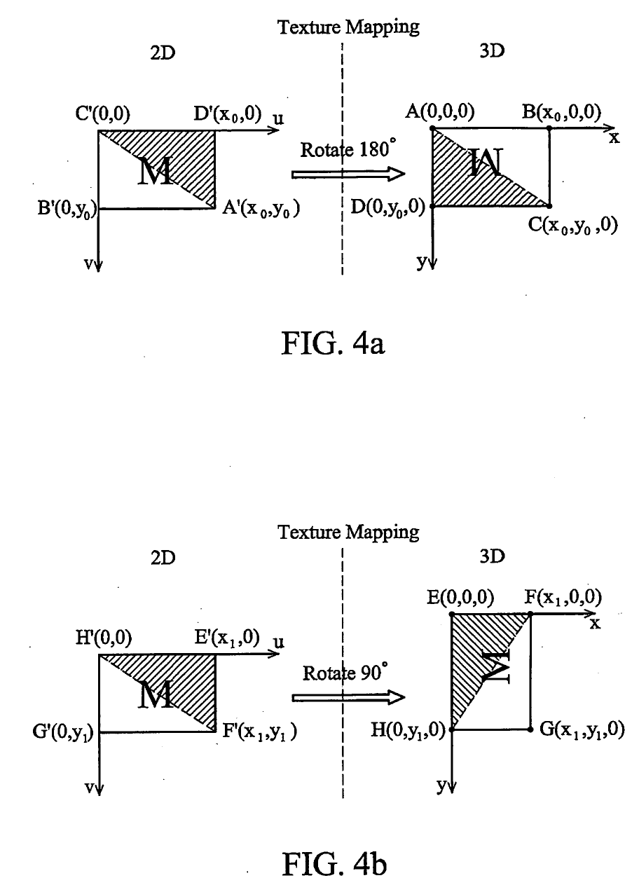

FIG. 4a illustrates a 2D texture rotated by 180° into a 3D texture. The original image of the triangle is filled with oblique lines. The texture mapping module 303 combines two triangles (triangle A′B′C′ and A′C′D′) to form a rectangle and thereby achieves the object of rotating the rectangle. For each vertex, the relation between 2D and 3D texture mapping is: the coordinates of the vertex A′ are transformed from (x₀, y₀) into (0,0,0); the coordinates of the vertex B′ are transformed from (0,y₀) into (x₀, 0,0); the coordinates of the vertex C′ are transformed from (0,0) into (x₀, y₀,0,); and the coordinates of the vertex D′ are transformed from (x₀, 0) into (0,y₀, 0).

FIG. 4b illustrates a 2D texture rotated by 90° into a 3D texture. The original image of the triangle is filled with oblique lines. The texture mapping module 303 combines two triangles (triangle E′F′H′ and F′G′H′) to form a rectangle and thereby achieves the object of rotating the rectangle. For each vertex, the relation between 2D and 3D texture mapping is: the coordinates of the vertex E′ are transformed from (x₁,0) into (0,0,0); the coordinates of the vertex F′ are transformed from (x₁, y₁) into (x₁, 0, 0); the coordinates of the vertex G′ are transformed from (0, y₁) into (x₁, y₁, 0); the coordinates of the vertex H′ are transformed from (0,0) into (0, y₁, 0).

The operation applied in the 3D engine is described as follows. The rotation object determination module 304 detects the shape, position, and rotation angle of the variation object in the image. The rotation module 302 rotates vertices of the triangles of the variation object. For example, in FIG. 4a, two triangles (triangle A′B′C′ and A′C′D′) are rotated. The coordinates of the vertex A′ are transformed from 2D coordinates (x₀, y₀) into 3D coordinates (0,0,0); the coordinates of the vertex B′ are transformed from 2D coordinates (0, y₀) into 3D coordinates (x₀, 0, 0); the coordinates of the vertex C′ are transformed from 2D coordinates (0, 0) into 3D coordinates (x₀, y₀, 0); and the coordinates of the vertex D′ are transformed from 2D coordinates (x₀, 0) into 3D coordinates (0, y₀, 0). Finally, the texture mapping module 303 maps the texture on the original triangle to the rotated triangle.

After texture mapping, the replacing module 305 of the 3D engine 300 retains the first rotation image 254 except the rotated first image variation object 264, and replaces the rotated first image object 264 of the first rotation image 254 in the second memory block 312 with the second image rotation object 268 to form a rotated second image 258. Afterward, the display device 320 can refresh and display the rotated second image 258 in the second memory block 312. It should be noted that the rotation requirement can be preset by the system or users.

In the second embodiment, the rendering module 301, the rotation module 302, the texture mapping module 303, the rotation object determination module 304, and the replacing module 3b5 are components of the 3D engine 300, that is, they are implemented by hardware (hardware rendering) and performed by the graphics device, such as a graphics accelerator.

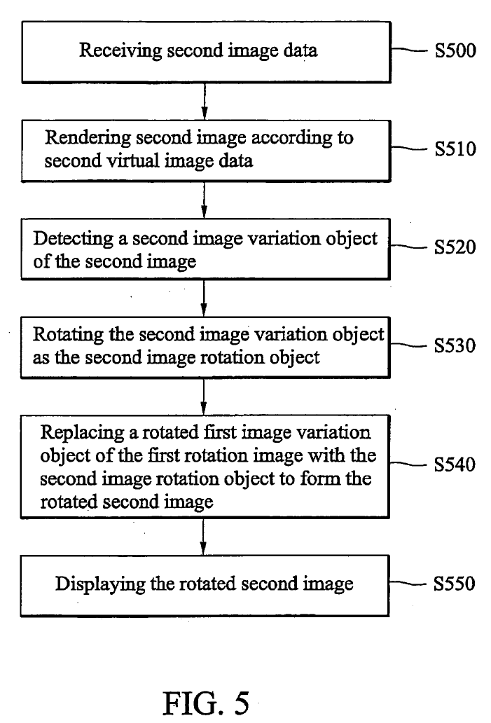

FIG. 5 illustrates the operation of the method for image rotation according to the embodiment of the present invention. Note that, the image data and prior image data received by the rendering module is referred to as the second image data and first image data, and the corresponding rotated image is referred to as the rotated second image 258 and first rotation image 254, respectively.

First, in step S500, second image data is received, and in step S510, a second image 256 is rendered according to the second image data, and stored.

Then, in step S520, a second image variation object 266 in the second image 256 is detected according to a first. image 252 and the second image 256, to identify a first image variation object 262 of the first image 252, a second image variation object 266 of the second image 256, and a rotated first image variation object 264 of the first rotation image 254, which is a rotated image of a first image 252. Thereafter, in step S530, the second image variation object 256 is rotated as a second image rotation object 268 according to the rotation requirement. Similarly, the rotation requirement can be preset by the system or users. Thereafter, in step S540, the rotated first image variation object 264, which is a partial image of the first rotation image 254 corresponding to the position of the second image variation object 266 in the second image 256, is replaced with the second image rotation object 268 to form a rotated second image 258. Finally, in step S550, the rotated second image 258, which is the updated image, is refreshed and displayed.

It should be noted that if the image is rendered by the 3D engine, a texture is rotated according to a rotation requirement, and the rotated texture is texture mapped to the second image rotation object 268 before the rotated first image variation object 264 is replaced with the second image rotation object 268. Further, if the display device is rotated at an angle, the second image variation object 266 can be rotated according to the angle as the second image rotation object 268.

Similarly, the rendering process and rotation process can be implemented by software or hardware, and performed by the CPU or graphics accelerator, respectively.

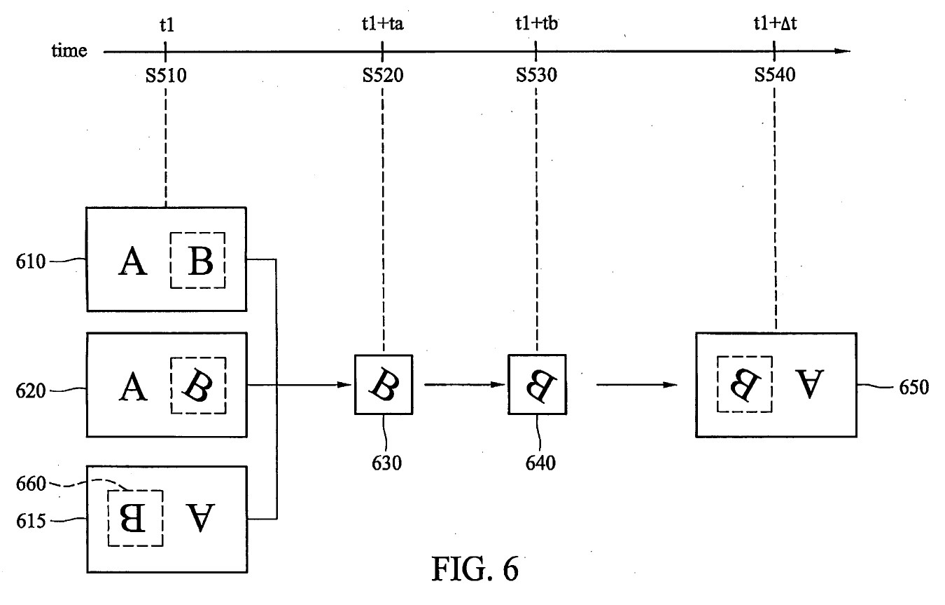

FIG. 6 illustrates an example of image rotation with time progress. At time t1, the system stores a first image 610, a second image 620 to show next, and a first rotation image 615. The first image 610, the second image 620 and the first rotation image 615 are stored in the rendering module 220, the first memory 200 and the frame buffer 230, respectively.

At time t1+ta, the rotation object determination module 224 detects a second image variation object 630 between the first image 610 and the second image 620. At time t1+tb, the rotation module 220 rotates the second image variation object 630 by 180° to generate a second image rotation object 640. At time t1+Δt, the rotated first image variation object 660, which is the partial image in the first rotation image 615, is replaced by the replacing module 222 with the second image rotation object 640, thereby generating the rotated second image 650, and the rotated second image 650 can then be displayed.

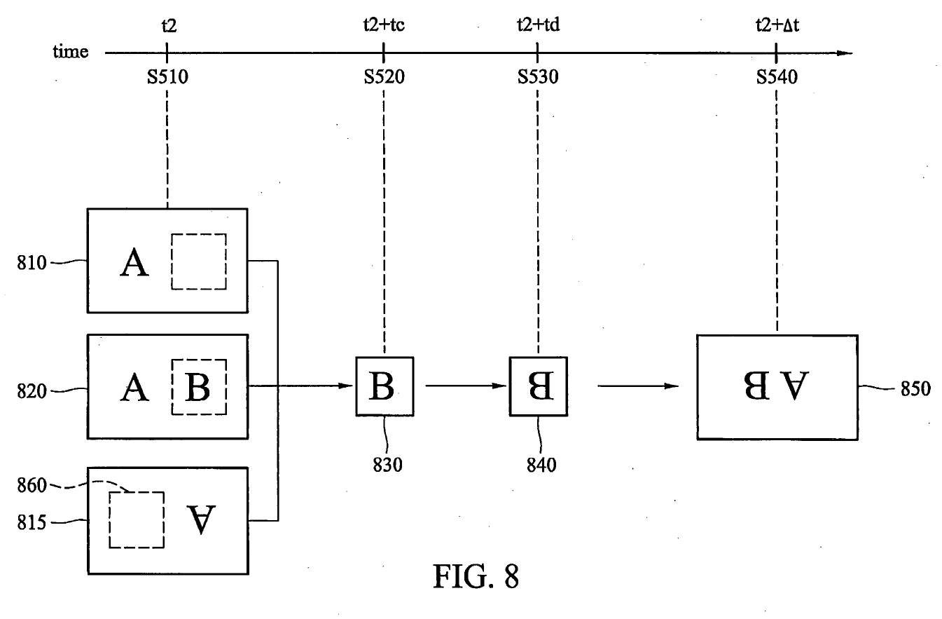

FIG. 8 illustrates another example of image rotation with time progress. At time t2, the system stores a first image 810, a second image 820 to show the next rendering image, and a first rotation image 815 which is the first image 810 rotated by 180°.

At time t2+tc, the rotation object determination module 224 detects a second image variation object 830 between the first image 810 and the second image 820. At time t2+td, the rotation module 220 rotates the second image variation object 830 by 180° to generate a second image rotation object 840. At time t2+Δt, the rotated first image variation object 860, which is the partial image in the first rotation image 815, is replaced by the replacing module 222 with the second image rotation object 840, thereby generating the rotated second image 850, and the rotated second image 850 can then be displayed.

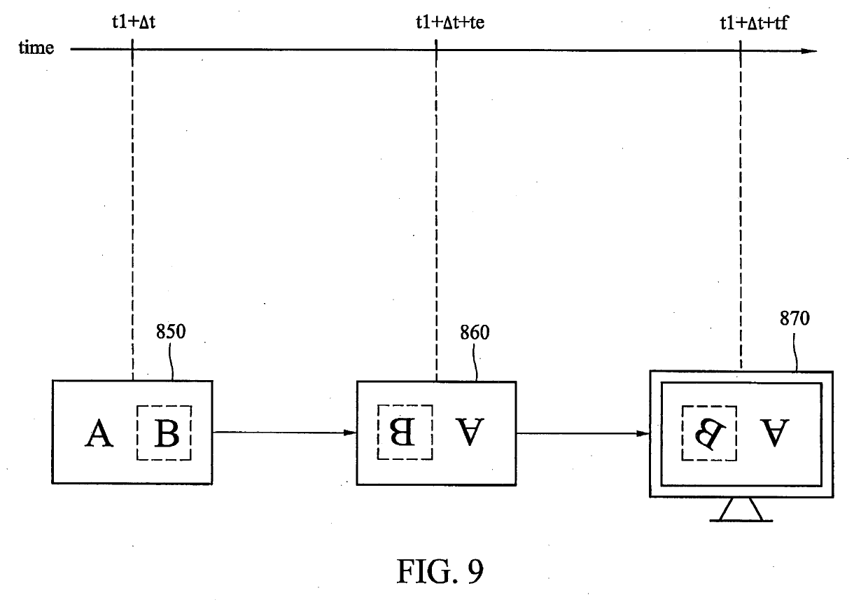

FIG. 9 illustrates the process of image rotation and image refreshing. First, the first image 950 is rotated as the first rotation image 960, and the rotated second image 970 is refreshed by the display device.

As a result, the apparatus and method for image rotation according to the present invention only needs to rotate the changed elements in the image without rendering the entire image, thereby improving system performance and reducing system resources used by the rendering process. Further, since the present invention can be implemented by hardware, such as graphics accelerators, the response time when refreshing the image in the frame buffer is reduced.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An apparatus for image rotation, comprising:
a first memory;
a frame buffer to store a first rotation image which is a rotated image of a first image;
a rendering module to receive second image data, render a second image according to the second image data, and store the second image in the first memory;
a rotation object determination module to detect a variation between the first image and the second image to identify a first image variation object of the first image, a second image variation object of the second image, and a rotated first image variation object of the first rotation image;
a rotation module to rotate the second image variation object as a second image rotation object; and
a replacing module to retain the first rotation image except the rotated first image variation object and replace the rotated first image object of the first rotation image with the second image rotation object to form a rotated second image.

2. The apparatus as claimed in claim 1, wherein the first image variation object in the first image and the rotated first image variation object in the first rotation image are located at a position corresponding to that of the second image variation object in the second image.

3. The apparatus as claimed in claim 1, further comprising a display device to refresh and display the rotated second image in the frame buffer.

4. The apparatus as claimed in claim 1 wherein the rendering module and the rotation module are implemented by software, and performed by the CPU of the computer system.

5. The apparatus as claimed in claim 1 wherein the first memory is located in the frame buffer.

6. The apparatus as claimed in claim 1 wherein the rendering module and the rotation module are implemented by hardware, and performed by a graphics accelerator.

7. A method for image rotation, comprising the steps of:
providing a first rotation image which is a rotated image of a first image;
receiving a second image data;
rendering a second image according to the second image data;
detecting a variation between the first image and the second image to identify a first image variation object of the first image, a second image variation object of the second image, and a rotated first image variation object of the first rotation image;
rotating the second image variation object as a second image rotation object; and
retaining the first rotation image except the rotated first image variation object and replacing the rotated first image object of the first rotation image with the second image rotation object to form a rotated second image.

8. The method as claimed in claim 7, wherein the first image variation object in the first image and the rotated first image variation object in the first rotation image are located at a position corresponding to that of the second image variation object in the second image.

9. The method as claimed in claim 7 further comprising storing the first rotation image in a frame buffer.

10. The method as claimed in claim 7 further comprising rotating a texture according to a rotation requirement, and texture mapping the rotated texture on the second image rotation object.

11. The method as claimed in claim 7 wherein the rendering process and rotation process are performed by the CPU of the computer system.

12. The method as claimed in claim 7 further comprising storing the second image in the frame buffer.

13. The method as claimed in claim 7 wherein the rendering process and rotation process are performed by a graphics accelerator.

14. The method as claimed in claim 7 wherein the second image variation object is rotated as the second image rotation object according to a display device with an angle rotated.

15. An apparatus for image rotation, comprising:
a frame buffer including a first memory block and a second memory block to store a first rotation image which is a rotated image of a first image;
a 3D engine, including:
a rendering module to receive second image data, render a second image according to the second image data, and store the second image in the first memory block;
a rotation object determination module to detect a variation between the first image and the second image to identify a first image variation object of the first image, a second image variation object of the second image, and a rotated first image variation object of the first rotation image;
a rotation module to rotate the second image variation object as a second image rotation object according to a rotation requirement;
a texture mapping module to rotate a texture according to the rotation requirement, and texture map the rotated texture on the second image rotation object; and
a replacing module to retain the first rotation image except the rotated first image variation object and replace the rotated first image object of the first rotation image with the second image rotation object to form a rotated second image after the second image rotation object is texture mapped;
wherein the first image variation object in the first image and the rotated first image variation object in the first rotation image are located at a position corresponding to that of the second image variation object in the second image.

16. The apparatus as claimed in claim 15 further comprising a display device to refresh and display the rotated second image in the second memory block.
